(19) United States
(12) Patent Application Publication
(10) Pub. No.: US 2009/0217376 A1
(43) Pub. Date: Aug. 27, 2009

(54) HOME-USE INFORMATION PRODUCT AND MOBILE TERMINAL

(75) Inventors: Tomohiro Iwama, Kanagawa (JP); Tsutomu Kito, Kanagawa (JP); Tomoharu Kaneko, Kanagawa (JP); Yasuhiro Aoyama, Tokyo (JP)

Correspondence Address: Dickinson Wright PLLC;James E. Ledbetter, Esq., International Square, 1875 Eye Street, N.W., Suite 1200, Washington, DC, 20006, US

(73) Assignee: MATSUSHITA ELECTRIC INDUSTRIAL CO., LTD., OSAKA (JP)

(21) Appl. No.: 11/719,493

(22) PCT Filed: Nov. 16, 2005
(86) PCT No.: PCT/JP2005/021044

§ 371 Date: May 16, 2007

(30) Foreign Application Priority Data
Nov. 17, 2004 (JP) 2004-333641

(51) Int. Cl. G06F 11/00; G06F 15/16

(52) U.S. Cl. 726/22

(57) ABSTRACT

A mobile terminal and a home-use information product capable of retaining the security even under a network attack, while achieving P2P connection. When detecting a network attack, a home-use information product (104) notifies a mobile terminal (102) of the network attack. When receiving the notification, the mobile terminal (102) closes the port of a P2P connection part (121), requests the home-use information product (104) to close its port, and causes the home-use information product (104) to close the P2P connection port of a NAT router (103).

### TECHNICAL FIELD

The present invention relates to information appliances and a mobile terminal that establish a peer-to-peer connection via a router.

### BACKGROUND ART

In recent years, along with the spread of data communication networks, the so-called “home network” is being widely used inside the household as well where information appliances with communication functions, computers, and other peripheral equipments are connected on a network and communication among the equipments is implemented. The home network performs communication among equipments connected to a network, shares data processing functions of the equipments, and thus provides convenience and comfort for the user in, for example, transmitting and receiving contents among the equipments. The home network is therefore expected to be spread more and more.

Incidentally, information appliances inside the household constituting a home network and outside IP (internet protocol) communication network are connected via a router with a network address translator (hereinafter “NAT router”), and, to enable arbitrary peer-to-peer (hereinafter “P2P”) connection from network equipments including a mobile terminal on the outside IP communication network to the information appliance inside the household, it is necessary to set a state where the P2P connection port of the NAT router is open, that is, a standby mode where P2P connection from outside is possible.

For example, in patent document 1, an outside server and information appliances constantly establish a session for connection to in-house equipments.

### Patent Document 1: Japanese Patent Application Laid-Open No. 2003-169075

### DISCLOSURE OF THE INVENTION

### Problems to be Solved by the Invention

Thus, the NAT router connecting the information appliances inside the household constituting the home network and outside IP communication network in a peer-to-peer manner, has the port in an open state. Therefore, if the port remains as is, the NAT router may be subjected to network attacks including (DoS (Denial of Service) attack and DDoS (Distributed Denial of Service)) targeting that port from the outside IP communication network.

Also, future mobile terminals are considered to have an IP network function including, for example, broadband LAN. Therefore, in the same situation as above, the P2P connection port of the mobile terminal is highly likely to be subjected to an attack.

It is therefore an object of the present invention to provide an information appliance and a mobile terminal that are able to implement a P2P connection between a mobile terminal outside the household and an information appliance inside the household, and ensure security even when the mobile terminal and the information appliance are subjected to a network attack.

### Means for Solving the Problem

An information appliance according to the present invention adopts a configuration having: a P2P connection section that establishes a P2P (peer to peer) connection to a mobile terminal on an IP (internet protocol) communication network via a router; a router operation section that changes setting information of a routing table of the router; and an attack detection section that detects a network attack, and in this appliance, the router operation section changes the setting information of the routing table of the router to close a P2P connection port of the router in response to the detection of the network attack by the attack detection section.

A mobile terminal according to the present invention adopts a configuration having: a P2P connection section that establishes a P2P (peer to peer) connection to an information appliance on an IP (internet protocol) communication network; a message receiving section that receives a message inputted from the information appliance via the P2P connection section; and a port operation section that performs open and close operations of a port of the P2P connection section, and, in this terminal, the port operation section performs the operations of closing the port of the P2P connection section after the message receiving section receives the message indicating an ongoing network attack from the information appliance.

An information appliance according to the present invention adopts a configuration having: a P2P connection section that establishes a P2P (peer to peer) connection to the mobile terminal of claim 2 via a router; an attack detection section the detects a network attack; and a message transmission section that transmits a message to the mobile terminal via the P2P connection section and the router, and in this appliance, the message transmission section transmits to the mobile terminal the message indicating the ongoing network attack in response to detection of the network attack by the attack detection section.

### ADVANTAGEOUS EFFECT OF THE INVENTION

According to the present invention, it is possible to implement a P2P connection between a mobile terminal outside the household and an information appliance inside the household, and close the P2P connection port when the mobile terminal and the information appliance are subjected to a network attack, thereby ensuring security.

### BRIEF DESCRIPTION OF DRAWINGS

FIG. 1 is a block diagram showing a configuration of a P2P connection system according to Embodiment 1 of the present invention;

FIG. 2 is a sequence diagram explaining the operations against a network attack in the P2P connection system shown in FIG. 1;

FIG. 3 is a block diagram showing a configuration of a P2P connection system according to Embodiment 2 of the present invention;

FIG. 4 is a sequence diagram explaining the operations against a network attack in the P2P connection system shown in FIG. 3;

FIG. 5 is a block diagram showing a configuration of a P2P connection system according to Embodiment 3 of the present invention;

FIG. 6 is a sequence diagram explaining the operations against a network attack in the P2P connection system shown in FIG. 5;

FIG. 7 is a block diagram showing a configuration of a P2P connection system according to Embodiment 4 of the present invention; and

FIG. 8 is a sequence diagram explaining the operations against a network attack in the P2P connection system shown in FIG. 7.

### BEST MODE FOR CARRYING OUT THE INVENTION

Embodiments of the present invention will be described below in detail with reference to the accompanying drawings.

### Embodiment 1

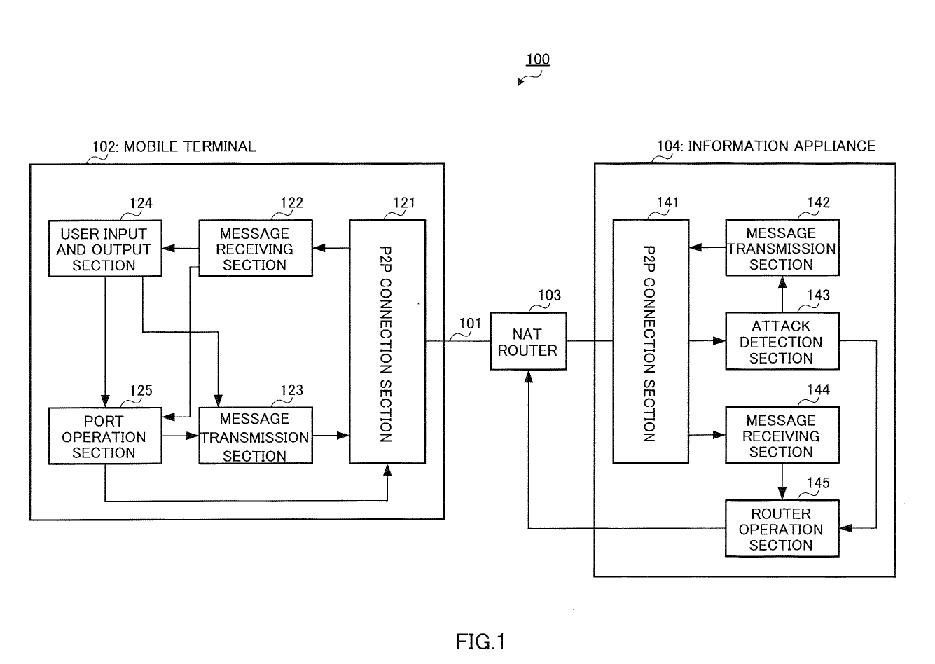

FIG. 1 is a block diagram showing a configuration of a P2P connection system according to Embodiment 1 of the present invention. As shown in FIG. 1, P2P connection system 100 according to this Embodiment 1 is configured with mobile terminal 102 directly connected with IP communication network 101 and information appliance 104 connected to IP communication network 101 via NAT router 103.

Mobile terminal 102 has: P2P connection section 121 that directly accesses IP communication network 101, connects to a communicating apparatus existing on IP communication network 101, and enables direct communication between the two; message receiving section 122 that performs receiving processing on a message that P2P connection section 121 receives from the communicating apparatus on IP communication network 101; message transmission section 123 that transmits a message to the communicating terminal of IP communication network 101 using P2P connection section 121; user input and output section 124 that receives a message indicating an ongoing network attack from message receiving section 122, reports the message to the user, and encourages the user to select whether or not to close the port of P2P connection section 121 and input the result; and port operation section 125 that performs open/close operations of the port of P2P connection section 121.

Also, information appliance 104 has: P2P connection section 141 that accesses IP communication network 101, connects to a communicating apparatus existing on IP communication network, and enables direct communication between the two; message transmission section 142 that transmits a message to the communicating terminal of IP communication network 101 using P2P connection section 141; attack detection section 143 that detects a network attack on the port of NAT router 103 which is open for P2P connection section 141; message receiving section 144 that performs receiving processing on the message that P2P connection section 141 receives from the communicating apparatus on IP communication network 101; and router operation section 145 that rewrites routing information of NAT router 103 and sets opening or closing of the port of NAT router 103 and IP masquerade.

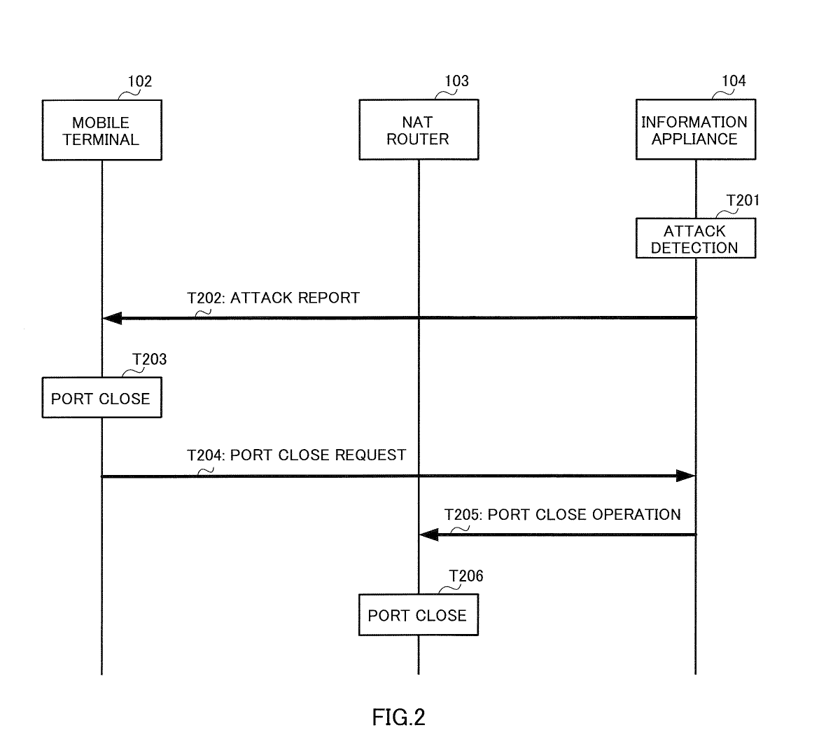

Next, the operations against a network attack in P2P connection system 100 configured as above will be described according to FIG. 2 with reference to FIG. 1. FIG. 2 is a sequence diagram explaining the operations against the network attack in the P2P connection system shown in FIG. 1.

In FIG. 2, in step T201, upon detecting a network attack, attack detection section 143 of information appliance 104 reports this to message transmission section 142 and router operation section 145.

In step T202, message transmission section 142 of information appliance 104 creates a message indicating the ongoing network attack and reports the message to mobile terminal 102 on the IP network, via P2P connection section 141 and NAT router 103.

In step T203, the operations of closing the port of P2P connection section 121 are performed in the following steps. That is, P2P connection section 121 of mobile terminal 102 provides the message received from the IP network to message receiving section 122. Message receiving section 122 decodes the received message and provides the result to user input and output section 124 and port operation section 125. Upon receiving the message indicating an ongoing network attack from message receiving section 122, user input and output section 124 reports the message to the user and encourages the user to select whether or not to close the port of P2P connection section 121 and input the result.

Upon receiving an instruction to close the port from the user, user input and output section 124 provides the instruction to message transmission section 123 and port operation section 125. Upon receiving the instruction from the user to close the port from user input and output section 124, port operation section 125 confirms receipt of the message indicating the ongoing network attack, from message receiving section 122, and performs the operations of closing the port of P2P connection section 121.

In step T204, upon receiving the instruction from the user to close the port from user input and output section 124, message transmission section 123 creates a message to close the P2P connection port of information appliance 104 and reports this message to information appliance 104 on the IP network via P2P connection section 121.

In step T205, message receiving section 144 of information appliance 104 receives the message to close the P2P connection port of information appliance 104 via NAT router 103 and P2P connection section 141, reports the message to router operation section 145, and encourages the operations of closing the P2P connection port of NAT router 103.

In step T206, router operation section 145 has already received the network attack detection report from attack detection section 143 and, upon receiving the report of the instruction of closing operation from message receiving section 144, sets routing information to close the P2P connection port of NAT router 103.

As described above, according to Embodiment 1, when the P2P connection port of the NAT router on the information appliance side is subjected to a network attack, a report is sent to the user of the mobile terminal (mobile telephone) that allows the user to decide whether or not to close the port, so that the operations of closing the P2P connection port of the NAT router subjected to the network attack are possible according to the intention of the user.

Also, with a mobile terminal which is not actually subjected to a network attack, the P2P connection port of the NAT router is also closed, so that it is possible to prevent a network attack.

### Embodiment 2

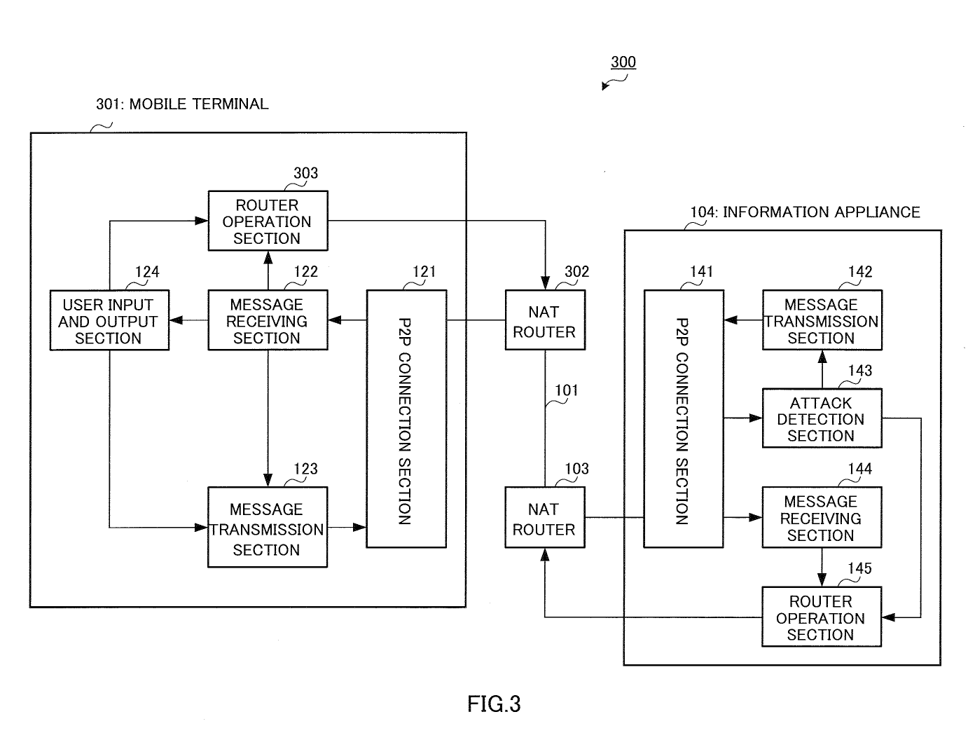

FIG. 3 is a block diagram showing a configuration of a P2P connection system according to Embodiment 2 of the present invention. In FIG. 3, components that are the same as or equivalent to the components shown in FIG. 1 (Embodiment 1) are assigned the same codes. Here, parts related to this Embodiment 2 will be mainly described.

As shown in FIG. 3, P2P connection system 300 according to this Embodiment 2 is provided with mobile terminal 301 in place of mobile terminal 102 in the configuration shown in FIG. 1 (Embodiment 1).

In mobile terminal 301, P2P connection section 121 communicates with a communicating apparatus positioned on IP communication network 102 via NAT router 302. Also, mobile terminal 102 shown in FIG. 1 (Embodiment 1) is provided with router operation section 303 that operates NAT router 302 in place of port operation section 125.

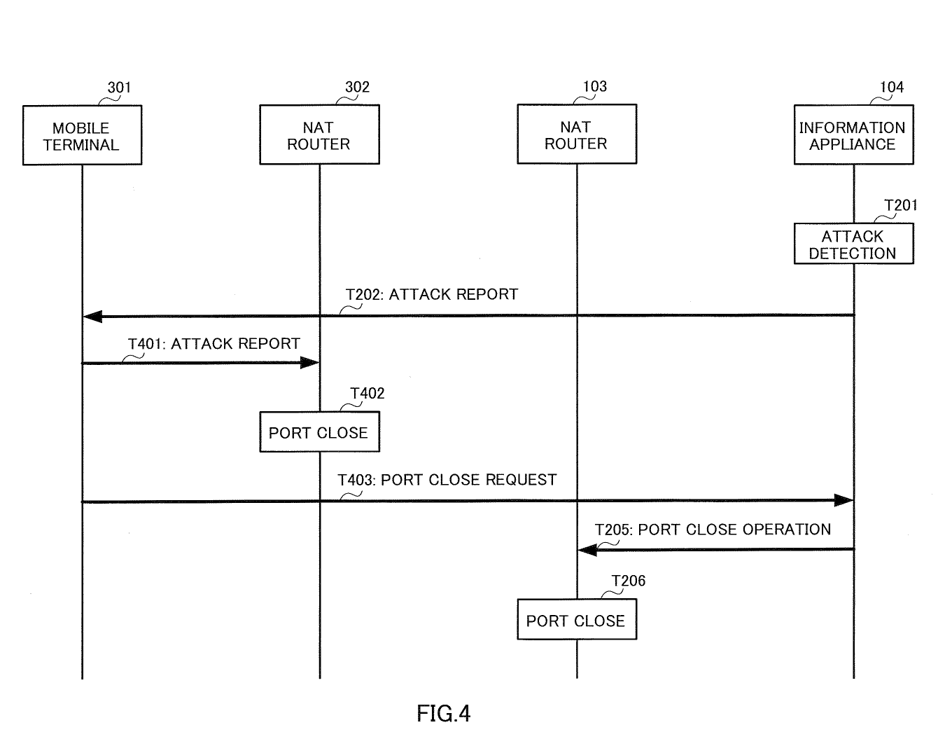

Next, the operations against a network attack in P2P connection system 300 as configured as above will be described according to FIG. 4 with reference to FIG. 3. FIG. 4 is a sequence diagram explaining the operations against a network attack in the P2P connection system shown in FIG. 3. In FIG. 4, the operational steps on information appliance 104 side are not changed and are assigned the same codes. Here, the steps and the operations on mobile terminal 301 side will be mainly described.

In step T401 of FIG. 4, the operations of closing the P2P connection port of NAT router 302 are performed in the following steps. That is, upon receiving a message indicating an ongoing network attack on the P2P connection port of information appliance 104, via NAT router 302 and P2P connection section 121, message receiving section 122 of mobile terminal 301 provides the message to user input and output section 124, message transmission section 123 and router operation section 303.

Upon receiving the message indicating the ongoing network attack from message receiving section 122, user input and output section 124 reports the message to the user and encourages the user to select whether or not to close the port of P2P connection section 121 and input the result. Then, upon receiving the instruction to close the port from the user, user input and output section 124 reports the instruction to router operation section 303 and encourages the operations of closing the P2P connection port of NAT router 302. Further, user input and output section 124 issues the report to message transmission section 123 as well.

In step T402, router operation section 303 has already received the message indicating that the P2P connection port of information appliance 104 is subjected to the network attack from message receiving section 122 and, upon receiving the report of the instruction of closing operation from user input and output section 124, sets routing information to close the P2P connection port of NAT router 302.

Then, in step T403, message transmission section 123 has already received the message indicating that the P2P connection port of information appliance 104 is subjected to the network attack from message receiving section 122, upon receiving the report of the instruction of closing operation from user input and output section 124, creates a message to close the P2P connection port of information appliance 104 and reports the message to information appliance 104 on the IP network via P2P connection section 121 and NAT router 302.

By this means, the information appliance 104 side also performs the operations of setting routing information to close the P2P connection port of NAT router 103 (steps T205 and T206).

As described above, according to Embodiment 2, when the P2P connection port of the NAT router on the information appliance side is subjected to a network attack, a report is sent to the user of the mobile terminal (mobile telephone) that allows the user to decide whether or not to close the port, so that the operations of closing the P2P connection port of the NAT router subjected to the network attack are possible according to the intention of the user.

Also, with a mobile terminal which is not actually subjected to a network attack, the P2P connection port of the NAT router is also closed, so that it is possible to prevent a network attack.

### Embodiment 3

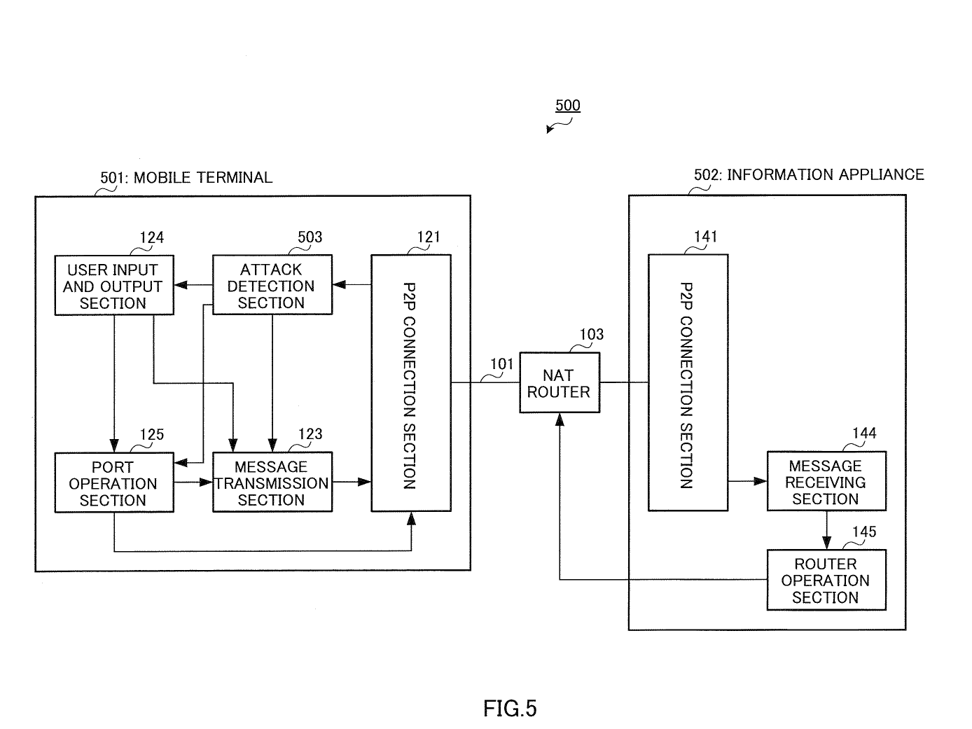

FIG. 5 is a block diagram showing a configuration of a P2P connection system according to Embodiment 3 of the present invention. In FIG. 5, components that are the same as or equivalent to the components shown in FIG. 1 (Embodiment 1) are assigned the same codes. Here, parts related to this Embodiment 3 will be mainly described.

As shown in FIG. 5, P2P connection system 500 according to this Embodiment 3 is provided with mobile terminal 501 and information appliance 502 in place of mobile terminal 102 and information appliance 104, respectively, in the configuration shown in FIG. 1 (Embodiment 1).

In mobile terminal 501, message receiving section 122 is removed and attack detection section 503 is provided in mobile terminal 102 shown in FIG. 1 (Embodiment 1). In addition, in information appliance 502, message receiving section 142 and attack detection section 143 are removed from information appliance 104 shown in FIG. 1 (Embodiment 1).

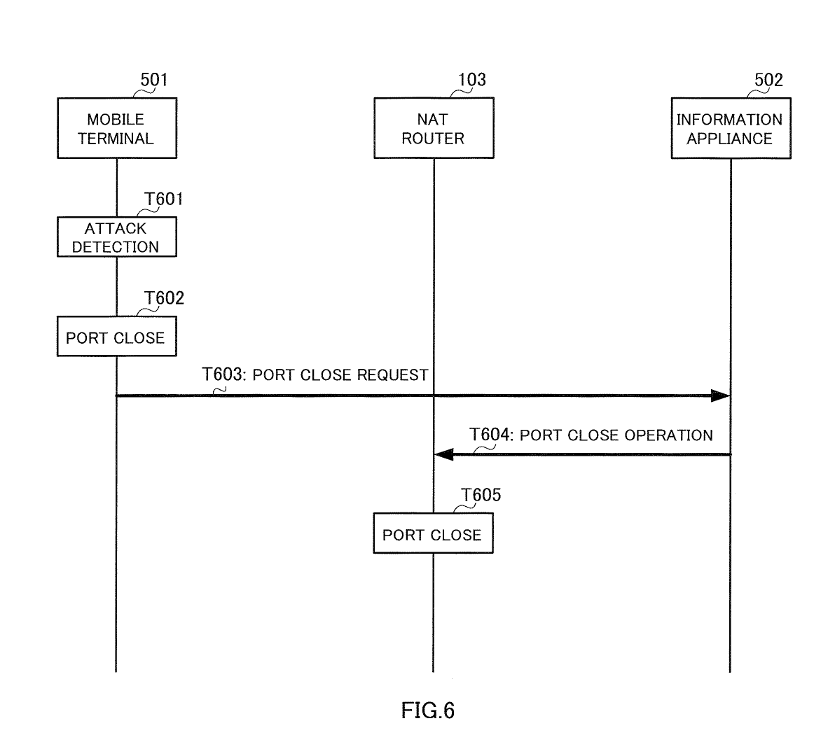

Next, the operations against a network attack in P2P connection system 500 configured as above will be described according to FIG. 6 with reference to FIG. 5. FIG. 6 is a sequence diagram explaining the operations against the network attack in the P2P connection system shown in FIG. 5.

In FIG. 6, in step T601, upon detecting a network attack, attack detection section 503 of mobile terminal 501 reports this to user input and output section 124, port operation section 125, and message transmission section 123.

In step T602, upon receiving the report indicating an ongoing network attack from attack detection section 503, user input and output section 124 reports this to the user and encourage the user to select whether or not to close the port of P2P connection section 121 and input the result. Upon receiving the instruction to close the port from the user, user input and output section 124 then provides the instruction to message transmission section 123 and port operation section 125. Port operation section 125 has already received the report indicating the ongoing network attack from attack detection section 503 and, upon receiving the instruction from the user to close the port from user input and output section 124, performs the operations of closing the port of P2P connection section 121.

In step T603, message transmission section 123 has already received the message indicating the ongoing network attack from attack detection section 503 and, upon receiving the instruction from the user to close the port from user input and output section 124, creates a message to close the P2P connection port of information appliance 502 and reports the message to information appliance 502 on the IP network via P2P connection section 121.

In step T604, message receiving section 144 of information appliance 502 receives the message to close the P2P connection port of information appliance 502, via NAT router 103 and P2P connection section 141, reports the message to router operation section 145, and encourages the operations of closing the P2P connection port of NAT router 103.

In step T605, upon receiving the report of the instruction of closing operation from message receiving section 144, router operation section 145 sets routing information to close the P2P connection port of NAT router 103.

As described above, according to Embodiment 3, when the port on the mobile terminal (mobile telephone) side is subjected to the network attack, a report is sent to the user of the mobile terminal that allows the user to decide whether or not to close the port, so that the operations of closing the P2P connection port subjected to the network attack are possible according to the intention of the user.

Also, with the information appliance side which is not actually subjected to the network attack, the P2P connection port of the NAT router is also closed, so that it is possible to prevent a network attack.

### Embodiment 4

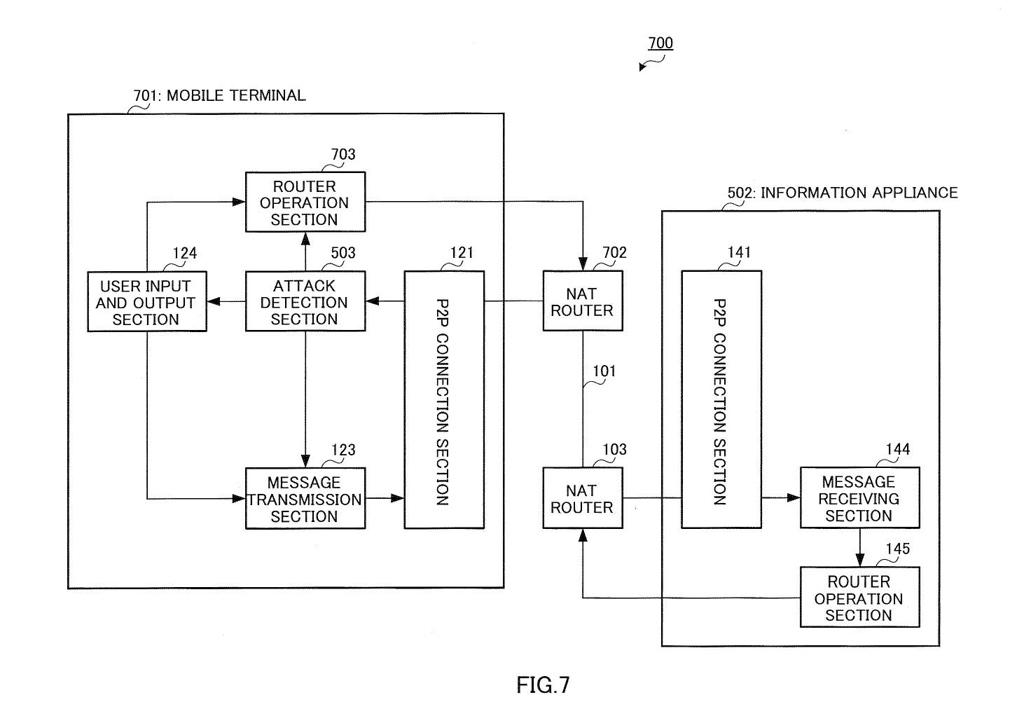

FIG. 7 is a block diagram showing a configuration of a P2P connection system according to Embodiment 4 of the present invention. In FIG. 7, components that are the same as or equivalent to the components shown in FIG. 5 (Embodiment 3) are assigned the same codes. Here, parts related to this Embodiment 4 will be mainly described.

As shown in FIG. 7, P2P connection system 700 according to this Embodiment 4 is provided with mobile terminal 701 in place of mobile terminal 501 in the configuration shown in FIG. 5 (Embodiment 3).

In mobile terminal 701, P2P connection section 121 communicates with a communicating apparatus positioned on IP communication network 101, via NAT router 702. Also, mobile terminal 501 shown in FIG. 5 (Embodiment 3) is provided with router operation section 703 that operates NAT router 702 in place of port operation section 125.

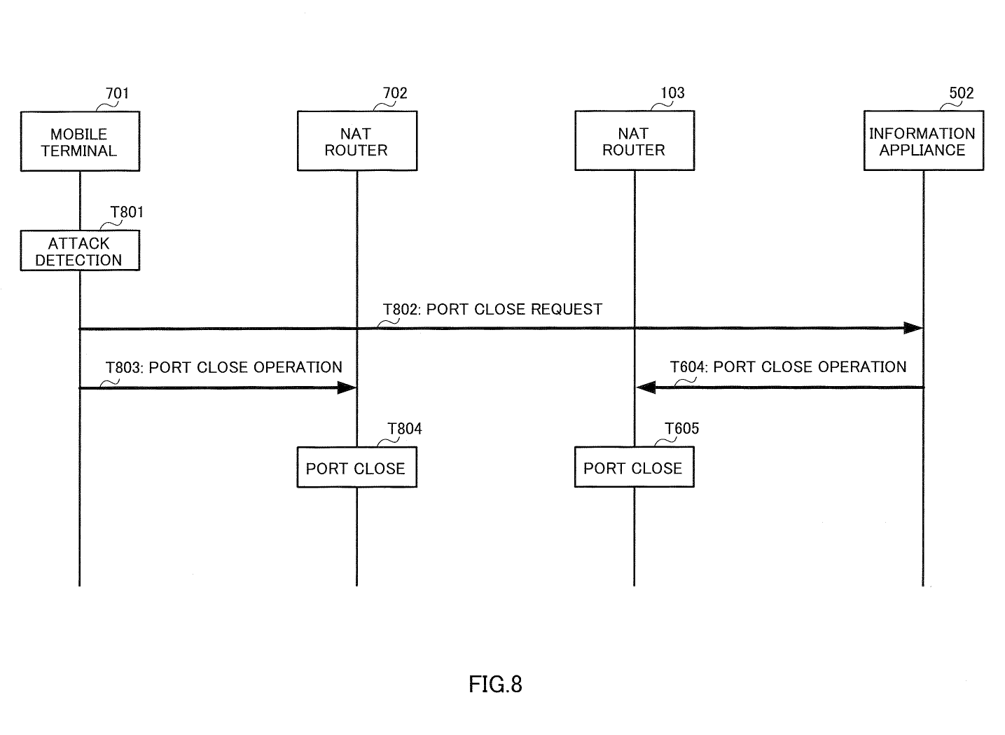

Next, the operations against a network attack in P2P connection system 700 configured as above will be described according to FIG. 8 with reference to FIG. 7. FIG. 8 is a sequence diagram explaining the operations against a network attack in the P2P connection system shown in FIG. 7. In FIG. 8, the operational steps on information appliance 502 side are not changed and are assigned the same codes. Here, the operations in the steps on mobile terminal 701 side will be mainly described.

In FIG. 8, in step T801, upon detecting a network attack, detection section 503 of mobile terminal 701 reports this to user input and output section 124, router operation section 703, and message transmission section 123.

In step T802, upon receiving the report indicating the ongoing network attack from attack detection section 503, user input and output section 124 reports the message to the user and encourages the user to select whether or not to close the P2P connection port of NAT router 702 and input the result. Then, upon receiving the instruction to close the port from the user, user input and output section 124 provides the instruction to message transmission section 123. Message transmission section 123 has already received the report indicating the ongoing network attack from attack detection section 503 and, upon receiving the instruction from the user to close the port from user input and output section 124, creates a message to close the P2P connection port of information appliance 502 and reports the message to information appliance 502 on the IP network, via P2P connection section 121 and NAT router 702.

In step T803, upon receiving the instruction to close the port from the user, user input and output section 124 provides the instruction to router operation section 703 and encourages the operations of closing the P2P connection port of NAT router 702.

In step T804, router operation section 703 has already received the network attack detection report from attack detection section 503 and, upon receiving the report of the instruction of closing operation from user input and output section 124, sets routing information to close the P2P connection port of NAT router 702.

Meanwhile, like Embodiment 3, the information appliance 502 side performs the operations of setting routing information to close the P2P connection port of NAT router 103 (steps T604 and T605).

As described above, according to Embodiment 4, when the port on the mobile terminal (mobile telephone) side is subjected to a network attack, a report is sent to the user of the mobile terminal (mobile telephone) that allows the user to decide whether or not to close the port, so that the operations of closing the P2P connection port of the NAT router subjected to a network attack are possible according to the intention of the user.

Also, with the information appliance side which is not actually subjected to the network attack, the P2P connection port of the NAT router is also closed, so that it is possible to prevent a network attack.

Here, the present invention may adopt, for example, configurations described below in addition to the configurations described above. That is, information appliance may adopt a configuration having: a P2P connection means that establishes a P2P connection to a mobile terminal on an IP communication network via a router; a router operation means that changes setting information of a routing table of the router; and an attack detection means that detects a network attack, and, in this appliance, the router operation means changes setting information of the routing table of the router to close the P2P connection port of the router in response to the detection of the network attack by the attack detection means.

Also, a mobile terminal may adopt a configuration having: a P2P connection means that establishes a P2P connection to an information appliance on an IP communication network; an attack detection means that detects a network attack; and a port operation means that performs open and close operations of the port of the P2P connection means, and, in this terminal, the port operation means closes the port of the P2P connection means in response to the detection of the network attack by the attack detection means.

Further, the mobile terminal may adopt a configuration having: a P2P connection means that establishes a P2P connection to the information appliance on an IP communication network; an attack detection means that detects a network attack; a user input and output means that encourages the user to perform selection and input; and a port operation means that performs open and close operations of the port of the P2P connection means, and, in this terminal, the user input and output means transmits to the user a query as to whether or not to close the port in response to the detection of the network attack by the attack detection means, and causes the port operation means to perform the operations of closing the port of the P2P connection means when the user selects to close the port.

Further, the mobile terminal may adopt a configuration having: a P2P connection means that establishes a P2P connection to an information appliance on an IP communication network; an attack detection means that detects a network attack; and a router operation means that changes setting information of a routing table of the router, and, in this terminal, the router operation means changes the setting information of the routing table of the router to close the P2P connection port of the router in response to the detection of the network attack by the attack detection means.

Furthermore, the mobile terminal may adopt a configuration having: a P2P connection means that establishes a P2P connection to the information appliance on the IP communication network; an attack detection means that detects a network attack; a user input and output means that encourages the user to perform selection and input; and a router operation means that changes setting information of a routing table of the router, and, in this terminal, the user input and output means transmits to the user a query as to whether or not to close the port in response to the detection of the network attack by the attack detection means, and causes the router operation means to change the setting information of the routing table of the router to close the P2P connection port of the router when the user selects to close the port.

This application is based on Japanese Patent Application No. 2004-333641, filed on Nov. 17, 2004, the entire content of which is expressly incorporated by reference herein.

### INDUSTRIAL APPLICABILITY

The present invention is useful for implementing a P2P connection between a mobile terminal outside the household and an information appliance inside the household and ensuring security when the mobile terminal and the information appliance are subjected to a network attack. The present invention is particularly suitable for a mobile terminal having IP network functions including, for example, broadband LAN.

1. An information appliance comprising:
a P2P connection section that establishes a P2P (peer to peer) connection to a mobile terminal on an IP (internet protocol) communication network via a router;
a router operation section that changes setting information of a routing table of the router; and
an attack detection section that detects a network attack,
wherein the router operation section changes the setting information of the routing table of the router to close a P2P connection port of the router in response to the detection of the network attack by the attack detection section.

2. A mobile terminal comprising:
a P2P connection section that establishes a P2P (peer to peer) connection to an information appliance on an IP (internet protocol) communication network via a router;
a message receiving section that receives a message inputted from the information appliance via the P2P connection section; and
a port operation section that performs open and close operations of a port of the P2P connection section,
wherein the port operation section performs the operations of closing the port of the P2P connection section after the message receiving section receives the message indicating an ongoing network attack from the information appliance.

3. An information appliance comprising:
a P2P connection section that establishes a P2P (peer to peer) connection to the mobile terminal of claim 2 via a router;
an attack detection section that detects a network attack; and
a message transmission section that transmits a message to the mobile terminal via the P2P connection section and the router,
wherein the message transmission section transmits to the mobile terminal the message indicating the ongoing network attack in response to the detection of the network attack by the attack detection section.
